(19) United States
(12) Patent Application Publication
(10) Pub. No.: US 2025/0379360 A1
(43) Pub. Date: Dec. 11, 2025

(54) PHASE SHIFTER AND BASE STATION ANTENNA

(71) Applicant: HUAWEI TECHNOLOGIES CO., LTD., Shenzhen (CN)

(72) Inventors: He Cui, Dongguan (CN); Yiwei Wu, Shenzhen (CN); Benzhi Zhu, Shenzhen (CN); Yixing Zeng, Shenzhen (CN); Yunlong Hu, Dongguan (CN)

(73) Assignee: HUAWEI TECHNOLOGIES CO., LTD., Shenzhen (CN)

(21) Appl. No.: 19/240,374

(22) Filed: Jun. 17, 2025

Related U.S. Application Data
(63) Continuation of application No. PCT/CN2023/136080, filed on Dec. 4, 2023.

(30) Foreign Application Priority Data
Dec. 26, 2022 (CN) 202211677793.1

(51) Int. Cl. H01Q 3/32; H01P 1/18; H01Q 1/24

(52) U.S. Cl. CPC H01Q 3/32; H01P 1/184; H01Q 1/246

(57) ABSTRACT

A phase shifter and a base station antenna. The phase shifter includes a cavity, a first phase shift assembly, and a second phase shift assembly. At least a part of the cavity is made of a metal material. The first phase shift assembly is connected to the cavity, the first phase shift assembly is grounded through the metal part of the cavity, and the first phase shift assembly includes an input port and an output port. The second phase shift assembly is slidably disposed in the cavity, and is coupled to the first phase shift assembly. At least the part of the cavity of the phase shifter is made of the metal material, so that the first phase shift assembly can be grounded through the metal material part of the cavity, and no additional grounding apparatus needs to be arranged in the cavity.

### CROSS-REFERENCE TO RELATED APPLICATIONS

This application is a continuation of International Application No. PCT/CN2023/136080, filed on Dec. 4, 2023, which claims priority to Chinese Patent Application No. 202211677793.1, filed on Dec. 26, 2022. The disclosures of the aforementioned applications are hereby incorporated by reference in their entireties.

### TECHNICAL FIELD

The embodiments to the field of communication technologies, and to a phase shifter and a base station antenna.

### BACKGROUND

With development of mobile communication technologies, there is an increasingly strong requirement for miniaturization and high gains of base station antennas. As a core component of a base station antenna, a phase shifter plays a key role in implementing an electrical tilt of the base station antenna. However, in current phase shifter technologies, there are mainly a physical phase shifter and a dielectric phase shifter. The physical phase shifter changes a physical length of a strip through a sliding coupling apparatus, to implement a phase change. However, a conventional physical phase shifter is usually characterized by a large volume, difficult integration, and the like. Therefore, a miniaturized and easily integrated phase shifter is urgently needed to meet a development requirement of current communication technologies.

### SUMMARY

An objective of the embodiments is to provide a phase shifter and a base station antenna, to resolve the foregoing problem that an existing phase shifter has a large volume and is difficult to be integrated.

A first aspect of the embodiments provides a phase shifter, including:
a cavity, where at least a part of the cavity is made of a metal material;
a first phase shift assembly, where the first phase shift assembly is connected to the cavity, the first phase shift assembly is grounded through the metal part of the cavity, and the first phase shift assembly includes an input port and an output port; and
a second phase shift assembly, where the second phase shift assembly is slidably disposed in the cavity, and is coupled to the first phase shift assembly.

According to the phase shifter provided in the embodiments, at least the part of the cavity of the phase shifter is made of the metal material, so that the first phase shift assembly can be grounded through the metal material part of the cavity, and no additional grounding apparatus needs to be arranged in the cavity. Therefore, a structure of the phase shifter is simplified, and arrangement requirements of the first phase shift assembly, the second phase shift assembly, and other components can be met even if the cavity has a small volume, thereby improving integration, facilitating a miniaturization design of the phase shifter, and implementing a phase shift function in limited space.

In a possible design or implementation, the input port and the output port are respectively located at two ends of the cavity in a length direction. Therefore, cables can be separately laid out for the input port and the output port from the two ends of the cavity, so that a cable layout operation is more convenient and more flexible.

In a possible design or implementation, the cavity includes a first side plate, a second side plate, and a bottom plate, the first side plate and the second side plate are respectively connected to two opposite ends of the bottom plate, and an opening is formed between an end that is of the first side plate and that is away from the bottom plate and an end that is of the second side plate and that is away from the bottom plate; and the first phase shift assembly is electrically coupled to metal parts of the first side plate and the second side plate and/or a metal part of the bottom plate.

The first side plate, the second side plate, and the bottom plate form a groove-shaped structure, in other words, installation space is formed between the first side plate, the second side plate, and the bottom plate. The installation space may be used to arrange the first phase shift assembly and the second phase shift assembly, and an end that is of the groove-shaped structure and that is away from the bottom plate has the opening. The first phase shift assembly, the second phase shift assembly, and other components may be installed in the cavity through the opening. This also facilitates detachment and maintenance.

In a possible design or implementation, the first phase shift assembly includes a first phase shift segment and a second phase shift segment, the first phase shift segment is electrically coupled to the first side plate and the bottom plate and/or the flange, and the second phase shift segment is electrically coupled to the second side plate and the bottom plate and/or the flange; and the input port is disposed in one of the first phase shift segment and the second phase shift segment, and the output port is disposed in the other.

The first phase shift segment and the second phase shift segment may be metal strips, and an air medium is filled between the metal strips and the cavity, so that the first phase shift segment and the second phase shift segment form an air microstrip. The air microstrip has a smaller loss than a common microstrip. For example, if a difference loss of a common microstrip is 1, a difference loss of an air microstrip in a same length and same material condition is less than 1. Therefore, performance is better.

In a possible design or implementation, the phase shifter further includes a first connecting piece, and two ends of the first connecting piece are respectively connected to the cavity and the first phase shift assembly, so that the first phase shift assembly is coupled to the cavity.

The first connecting piece may be a dielectric block, has a small volume, may be fastened at a specified proper position between an inner wall of the cavity and the first phase shift assembly, and does not occupy large space while implementing connection and fastening between the cavity and the first phase shift assembly. The first connecting piece is disposed, so that a specific gap can be kept between the first phase shift assembly and the cavity, and the first phase shift assembly can form an air microstrip, to reduce a loss, thereby facilitating a low-loss phase shifter.

In a possible design or implementation, a clamping groove is disposed in the first connecting piece, and the first phase shift assembly is clamped in the clamping groove. The clamping manner can ensure reliability of fastening the first phase shift assembly, and can also facilitate installation/detachment and maintenance of the first phase shift assembly, and is easy to operate.

In a possible design or implementation, the second phase shift assembly includes a sliding dielectric and a second connecting piece, the second connecting piece is connected to the cavity, the sliding dielectric is slidably connected to the second connecting piece, and a position of the sliding dielectric is aligned with a position of the first phase shift assembly. The second connecting piece can support the sliding dielectric, to ensure that the sliding dielectric can stably move between the first phase shift segment and the second phase shift segment, thereby implementing phase adjustment.

In a possible design or implementation, a through hole is provided in the second connecting piece, the sliding dielectric penetrates through the through hole, a sliding slot is disposed on an inner wall of the second connecting piece, and the sliding dielectric is slidably connected to the sliding slot.

The sliding dielectric may be accommodated in the through hole. The through hole can provide stable support for the sliding dielectric, and can also provide space for movement of the sliding dielectric. In addition, the sliding slot is disposed, so that sliding of the sliding dielectric can be guided, thereby ensuring that the sliding dielectric can stably slide.

In a possible design or implementation, the sliding dielectric includes a first sliding part, a second sliding part, and a connecting part, and the first sliding part and the second sliding part are respectively connected to two opposite ends of the connecting part, so that the first sliding part, the second sliding part, and the connecting part form a U shape; and the first sliding part and the second sliding part are respectively slidably connected to corresponding sliding slots on the inner wall of the second connecting piece.

The first sliding part and the second sliding part are slidably connected to the corresponding sliding slots, so that sliding stability of the sliding dielectric can be ensured.

In a possible design or implementation, the second phase shift assembly further includes a dielectric pull-rod, and the dielectric pull-rod is connected to the sliding dielectric. The dielectric pull-rod may be controlled, through a transmission apparatus, to move, and can drive the sliding dielectric to synchronously move, thereby implementing a limiting adjustment function.

In a possible design or implementation, a material of the second connecting piece is plastic, rubber, or silica gel. On one hand, insulation between the sliding dielectric and the first phase shift assembly can be implemented. On the other hand, the material has better flexibility than a metal material, so that structural components can be protected, and lightweight implementation is further facilitated.

In a possible design or implementation, the second connecting piece is connected to the cavity through a screw or a rivet, or is connected to the cavity by using a hot melt process. Therefore, reliability of fastening between the second connecting piece and the cavity can be ensured, so that the second connecting piece can provide stable support for the sliding dielectric, to ensure stability of sliding of the sliding dielectric relative to the second connecting piece.

A second aspect of the embodiments further provides a base station antenna, including the phase shifter provided in the first aspect of the embodiments.

It should be understood that the foregoing general descriptions and the following detailed descriptions are merely used as an example, and should not limit the embodiments.

### BRIEF DESCRIPTION OF DRAWINGS

FIG. 1 is a diagram of a structure of a base station antenna according to an embodiment;

FIG. 2 is a diagram of a structure of a phase shifter according to an embodiment;

FIG. 3 is a diagram of fitting between a cavity and a first phase shift assembly of a phase shifter according to an embodiment;

FIG. 4 is a top view of fitting between a cavity and a first phase shift assembly of a phase shifter according to an embodiment;

FIG. 5 is a diagram of a structure of a cavity of a phase shifter according to an embodiment;

FIG. 6 is a diagram of a structure of a cavity of a phase shifter according to another embodiment;

FIG. 7 is a side view of fitting between a cavity and a first phase shift assembly of a phase shifter according to another embodiment;

FIG. 8 is a diagram of a structure of a first phase shift segment according to an embodiment;

FIG. 9 is a diagram of a structure of a first phase shift segment according to another embodiment;

FIG. 10 is a diagram of a structure of a first connecting piece;

FIG. 11 is a diagram of a structure of a second connecting piece according to an embodiment;

FIG. 12 is a diagram of a structure of a sliding dielectric according to an embodiment; and

FIG. 13 is a diagram of a structure of a sliding dielectric according to another embodiment.

The accompanying drawings herein are incorporated to show embodiments, and are used together to explain the principles of the embodiments.

### DESCRIPTION OF EMBODIMENTS

To better understand solutions of the embodiments, the following describes embodiments in detail with reference to the accompanying drawings. It should be understood that the specific embodiments described herein are merely used for explanations, but are not intended as limiting.

In descriptions of the embodiments, unless otherwise specified and limited, the terms “first” and “second” are merely intended for a purpose of description, and cannot be understood as an indication or implication of relative importance. Unless otherwise specified or stated, the term “a plurality of” means two or more than two. The terms “connection”, “fastening”, and the like should be understood in a broad sense. For example, “connection” may be a fastened connection, or may be a detachable connection, an integrated connection, or an electrical connection; or may be a direct connection, or may be an indirect connection through an intermediate medium. A person of ordinary skill in the art may understand specific meanings of the foregoing terms in the embodiments based on a specific case.

As a core component of a base station antenna, a phase shifter plays a key role in implementing an electrical tilt of the base station antenna. However, in current phase shifter technologies, there are a physical phase shifter and a dielectric phase shifter. The physical phase shifter can include a cavity 1, a sliding coupling apparatus, and the like. The cavity 1 is enclosed around, and can enclose the sliding coupling apparatus. The physical phase shifter changes a physical length of a strip through the sliding coupling apparatus, to implement a phase change. A cavity 1 of a conventional phase shifter can be made of an insulating material such as plastic, and an additional grounding apparatus needs to be arranged to implement grounding. This needs to occupy additional space in the cavity 1, and consequently it is difficult to assemble a surrounding strip and a sliding coupling apparatus. Sometimes, assembly requirements of internal components can be met only by designing a cavity 1 with a large volume. This does not facilitate miniaturization.

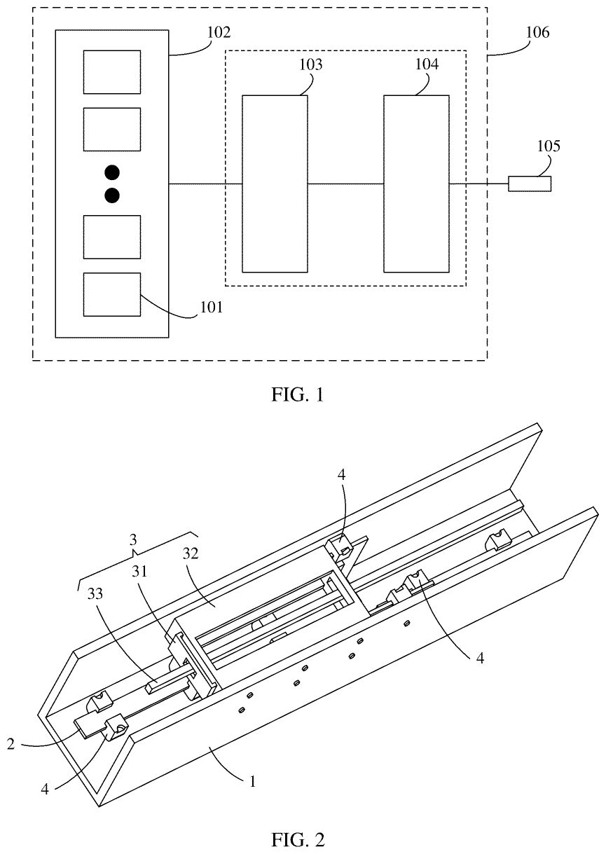

FIG. 1 is a diagram of a structure of a base station antenna according to an embodiment. Referring to FIG. 1, this embodiment provides a phase shifter. The phase shifter may be used in the base station antenna. The base station antenna may be used in radar, broadcast, communication, and other fields. The base station antenna includes an antenna array 101, a reflection panel 102, a phase shift network 103, a combiner or filter 104, a joint 105, and a radome 106. The antenna array 101 receives or transmits a radio frequency signal through a feeding network including the phase shift network 103 and the combiner or filter 104. The feeding network can feed a radio frequency signal to the antenna array 101 based on a specific amplitude and phase, or send a radio signal received by the antenna array 101 to a signal processing unit of a base station system through the antenna joint 105 based on a specific amplitude and phase. The radome 106 may protect internal components from electromagnetic interference in an external environment, damage from an external foreign object, and other risks.

The phase shift network 103 includes the phase shifter provided in this embodiment. FIG. 2 is a diagram of a structure of a phase shifter according to an embodiment. Referring to FIG. 2, the phase shifter includes a cavity 1, a first phase shift assembly 2, and a second phase shift assembly 3. At least a part of the cavity 1 is made of a metal material. The first phase shift assembly 2 is connected to the cavity 1, the first phase shift assembly 2 is grounded through the metal part of the cavity 1, and the first phase shift assembly 2 includes an input port 211 and an output port 221. The second phase shift assembly 3 is slidably disposed in the cavity 1, and is coupled to the first phase shift assembly 2.

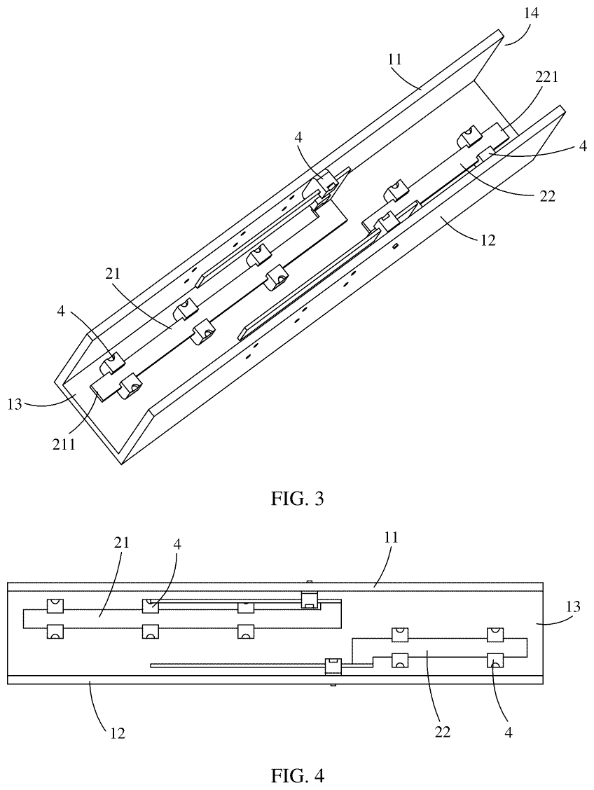

FIG. 3 is a diagram of fitting between a cavity 1 and a first phase shift assembly 2 of a phase shifter according to an embodiment, and FIG. 4 is a top view of fitting between a cavity 1 and a first phase shift assembly 2 of a phase shifter according to an embodiment. Referring to FIG. 3 and FIG. 4, the first phase shift assembly 2 is fastened relative to the cavity 1. As a main line for signal transmission, the first phase shift assembly 2 has the input port 211 and the output port 221. A signal may be input from the input port 211. The second phase shift assembly 3 moves relative to the first phase shift assembly 2, so that an electrical length in a circuit can be adjusted to implement phase adjustment of the output port 221, and the signal can be output from the output port 221.

In this embodiment, at least the part of the cavity 1 of the phase shifter is made of the metal material, so that the first phase shift assembly 2 can be grounded through the metal material part of the cavity 1, and no additional grounding apparatus needs to be arranged in the cavity 1. Therefore, a structure of the phase shifter is simplified, and arrangement requirements of the first phase shift assembly 2, the second phase shift assembly 3, and other components can be met even if the cavity 1 has a small volume, thereby improving integration, facilitating a miniaturization design of the phase shifter, and implementing a phase shift function in limited space.

At least the part of the cavity 1 is made of the metal material. For example, all parts of the cavity 1 may be made of the metal material, for example, copper or aluminum, so that processing and manufacturing of the cavity 1 can be facilitated. Also, one part of the cavity 1 may be made of the metal material, and the other part may be made of a non-metal material. A weight of the non-metal material is less than a weight of the metal material. The metal material and the non-metal material are combined, so that the cavity 1 can be lightweight on a premise that grounding is implemented through the cavity 1.

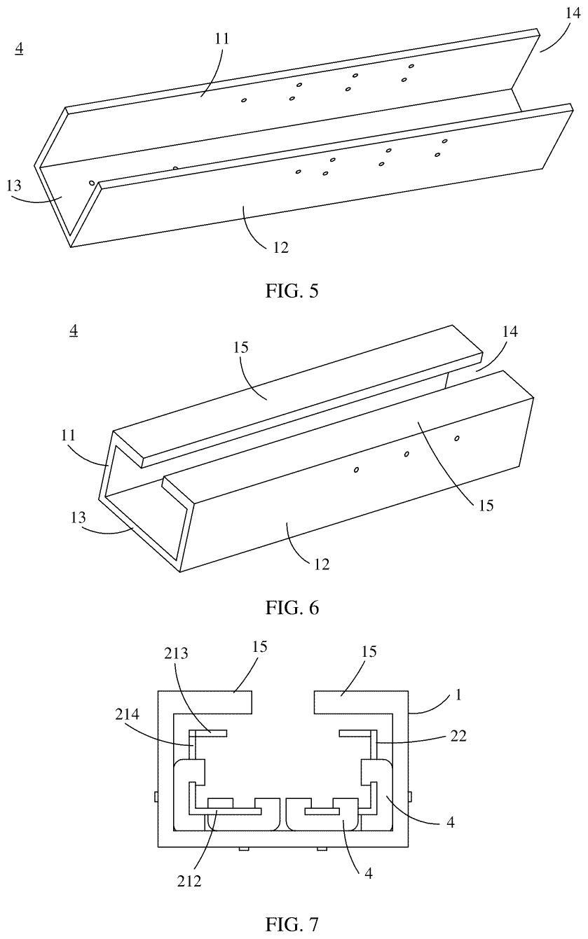

In a specific implementation, FIG. 5 is a diagram of a structure of a cavity 1 of a phase shifter according to an embodiment. Referring to FIG. 5, the cavity 1 includes a first side plate 11, a second side plate 12, and a bottom plate 13, the first side plate 11 and the second side plate 12 are respectively connected to two opposite ends of the bottom plate 13, and an opening 14 is formed between an end that is of the first side plate 11 and that is away from the bottom plate 13 and an end that is of the second side plate 12 and that is away from the bottom plate 13. The first phase shift assembly 2 is electrically coupled to metal parts of the first side plate 11 and the second side plate 12 and/or a metal part of the bottom plate 13.

Referring to FIG. 5, the first side plate 11, the second side plate 12, and the bottom plate 13 may all be made of the metal material, and the first phase shift assembly 2 is grounded through the first side plate 11, the second side plate 12, and the bottom plate 13. The first side plate 11 and the second side plate 12 may be symmetrically disposed at the two ends of the bottom plate 13, so that the first side plate 11, the second side plate 12, and the bottom plate 13 form a groove-shaped structure, in other words, installation space is formed between the first side plate 11, the second side plate 12, and the bottom plate 13. The installation space may be used to arrange the first phase shift assembly 2 and the second phase shift assembly 3, and an end that is of the groove-shaped structure and that is away from the bottom plate 13 has the opening 14. The first phase shift assembly 2, the second phase shift assembly 3, and other components may be installed in the cavity 1 through the opening 14. This also facilitates detachment and maintenance.

In addition, the first side plate 11 and the second side plate 12 each form a specific angle, for example, an acute angle, a right angle, or an obtuse angle, with the bottom plate 13. An angle between the first side plate 11 and the bottom plate 13 may be equal to or unequal to an angle between the second side plate 12 and the bottom plate 13. Therefore, a size of space in the cavity 1 and a shape of the cavity 1 can be changed, so that the cavity 1 can better match an ambient environment. In this embodiment, both the first side plate 11 and the second side plate 12 are perpendicular to the bottom plate 13, to form a U-shaped structure. This facilitates installation of the first phase shift assembly 2 and the second phase shift assembly 3, and also facilitates debugging of a fitting state of the first phase shift assembly 2 and the second phase shift assembly 3, to ensure stable implementation of a phase shift function.

The cavity 1 may be formed by using a sheet metal piece by using a bending process, so that processing and manufacturing of the cavity 1 can be facilitated.

In some other embodiments, FIG. 6 is a diagram of a structure of a cavity 1 of a phase shifter according to another embodiment, and FIG. 7 is a side view of fitting between a cavity 1 and a first phase shift assembly 2 of a phase shifter according to another embodiment. Referring to FIG. 6 and FIG. 7, the cavity 1 may also include a bottom plate 13, a first side plate 11, and a second side plate 12. The first side plate 11 and the second side plate 12 may be connected to two opposite ends of the bottom plate 13. Ends that are of the first side plate 11 and the second side plate 12 and that are away from the bottom plate 13 both have flanges 15. A flange 15 of the first side plate 11 bends toward the second side plate 12, a flange 15 of the second side plate 12 bends toward the first side plate 11, and a specific distance is kept between the flange 15 of the first side plate 11 and the flange 15 of the second side plate 12, to form the opening 14. The opening 14 can facilitate installation/detachment of the first phase shift assembly 2 and the second phase shift assembly 3. The flange 15 may also be made of the metal material, and can shield energy radiated by a surrounding antenna element from entering the cavity 1 to generate resonance, affecting antenna radiation performance. Referring to FIG. 7, the first phase shift assembly 2 may be electrically coupled to the side plates, the bottom plate 13, and the flanges 15 of the cavity 1, to implement grounding.

In a specific implementation, referring to FIG. 3 and FIG. 4, the input port 211 and the output port 221 are respectively located at two ends of the cavity 1 in a length direction.

The cavity 1 is of a slender structure. It may be understood that the slender structure has a length, a width, and a height. The space in the cavity 1 passes through two ends in a length direction of the slender structure. The input port 211 and the output port 221 of the first phase shift assembly 2 may be respectively located at the two ends of the cavity 1. Therefore, cables can be separately laid out for the input port 211 and the output port 221 from the two ends of the cavity 1, so that a cable layout operation is more convenient and more flexible.

In a specific implementation, referring to FIG. 3 and FIG. 4, the first phase shift assembly 2 includes a first phase shift segment 21 and a second phase shift segment 22, the first phase shift segment 21 is electrically coupled to the first side plate 11 and the bottom plate 13 and/or the flange 15, and the second phase shift segment 22 is electrically coupled to the second side plate 12 and the bottom plate 13 and/or the flange 15. The input port 211 is disposed in one of the first phase shift segment 21 and the second phase shift segment 22, and the output port 221 is disposed in the other. For example, the input port 211 may be disposed in the first phase shift segment 21, and the output port 221 may be disposed in the second phase shift segment 22. Alternatively, the output port 221 may be disposed in the first phase shift segment 21, and the input port 211 may be disposed in the second phase shift segment 22.

Referring to FIG. 4, the first phase shift segment 21 and the second phase shift segment 22 may be metal strips, and the metal strip may be of a strip-shaped thin sheet structure. The first phase shift segment 21 and the second phase shift segment 22 are not in direct contact with the cavity 1, and may be electrically connected to the metal material part of the cavity 1 in a coupling manner, to implement grounding. In this structure, an air medium is filled between the metal strips and the cavity 1, so that the first phase shift segment 21 and the second phase shift segment 22 form an air microstrip. The air microstrip has a smaller loss than a common microstrip. For example, if a difference loss of a common microstrip is 1, a difference loss of an air microstrip in a same length and same material condition is less than 1. Therefore, performance is better.

In the length direction of the cavity 1, the first phase shift segment 21 extends to one end of the cavity 1, and the second phase shift segment 22 extends to the other end of the cavity 1. Therefore, the input port 211 and the output port 221 are respectively located at the two ends of the cavity 1, so that cable layout can be more flexible and more convenient.

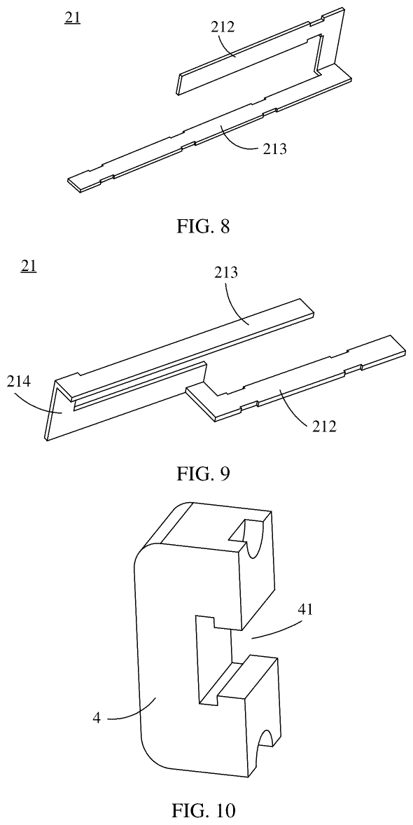

For example, FIG. 8 is a diagram of a structure of a first phase shift segment 21 according to an embodiment. Referring to FIG. 8, the first phase shift segment 21 includes a first part 212 and a second part 213. The first part 212 is coupled to the first side plate 11, and the second part 213 is coupled to the bottom plate 13, so that the first phase shift segment 21 can be flexibly arranged by using metal wall plates of the cavity 1. An arrangement manner of the second phase shift segment 22 and the first phase shift segment 21 may be the same as that of the first phase shift segment 21, and details are not described herein.

In addition, in some other embodiments, FIG. 9 is a diagram of a structure of a first phase shift segment 21 according to another embodiment. Referring to FIG. 7 and FIG. 9, the first phase shift segment 21 may alternatively include a first part 212, a second part 213, and a third part 214. Two ends of the third part 214 are respectively connected to the first part 212 and the second part 213. The first part 212 is coupled to the bottom plate 13, the second part 213 is coupled to the flange 15, and the third part 214 is coupled to the side plate, so that the first phase shift segment 21 can also be flexibly arranged.

In a specific implementation, referring to FIG. 3 and FIG. 4, the phase shifter further includes a first connecting piece 4, and two ends of the first connecting piece 4 are respectively connected to the cavity 1 and the first phase shift assembly 2, so that the first phase shift assembly 2 is coupled to the cavity 1.

The first connecting piece 4 may be a dielectric block, has a small volume, may be fastened at a specified proper position between an inner wall of the cavity 1 and the first phase shift assembly 2, and does not occupy large space while implementing connection and fastening between the cavity 1 and the first phase shift assembly 2. The first connecting piece 4 is disposed, so that a specific gap can be kept between the first phase shift assembly 2 and the cavity 1, and the first phase shift assembly 2 can form an air microstrip, to reduce a loss, thereby facilitating a low-loss phase shifter.

For example, FIG. 10 is a diagram of a structure of a first connecting piece 4. Referring to FIG. 10, a clamping groove 41 may be disposed in the first connecting piece 4, and the first phase shift assembly 2 may be clamped in the clamping groove 41. The clamping manner can ensure reliability of fastening the first phase shift assembly 2, and can also facilitate installation/detachment and maintenance of the first phase shift assembly 2, and is easy to operate.

In some other embodiments, the first phase shift assembly 2 may be of a structure in which a plastic piece is electroplated with a metal layer, the metal layer is used as a main line of the phase shifter, and an end of the metal layer may be connected to the input port 211 or the output port 221. The plastic piece may be connected to the cavity 1, and the metal layer is located at a position of the cavity 1 on the plastic piece.

In a specific implementation, referring to FIG. 1, the second phase shift assembly 3 includes a sliding dielectric 31 and a second connecting piece 32, the second connecting piece 32 is connected to the cavity 1, the sliding dielectric 31 is slidably connected to the second connecting piece 32, and a position of the sliding dielectric 31 is aligned with a position of the first phase shift assembly 2. A metal part may be disposed on the sliding dielectric 31; or the sliding dielectric 31 may include a non-metal part and a metal part, and the non-metal part and the metal part may be connected through a connecting piece, so that the metal part can synchronously move when the sliding dielectric 31 moves, thereby implementing a phase shift.

The second connecting piece 32 is made of an insulating material, and can isolate the sliding dielectric 31 from the first phase shift assembly 2, to implement coupling between the sliding dielectric 31 and the first phase shift assembly 2. Because the sliding dielectric 31 is coupled to an aligned part of the first phase shift assembly 2, when the sliding dielectric 31 moves to a different position relative to the second connecting piece 32, an amount of coupling between the sliding dielectric 31 and the first phase shift assembly 2 may be changed, so that an electrical length in a circuit may be changed, thereby implementing phase adjustment of each output port 221.

The second connecting piece 32 may be connected to the cavity 1 through a screw or a rivet, or may be connected to the cavity 1 by using a hot melt process. Therefore, reliability of fastening between the second connecting piece 32 and the cavity 1 can be ensured, so that the second connecting piece 32 can provide stable support for the sliding dielectric 31, to ensure stability of sliding of the sliding dielectric 31 relative to the second connecting piece 32.

In a specific implementation, a material of the second connecting piece 32 may be plastic, rubber, or silica gel. On one hand, insulation between the sliding dielectric 31 and the first phase shift assembly 2 can be implemented. On the other hand, the material has better flexibility than a metal material, so that structural components can be protected, and lightweight implementation is further facilitated. Also, the second connecting piece 32 may alternatively be another insulating material. This is not limited.

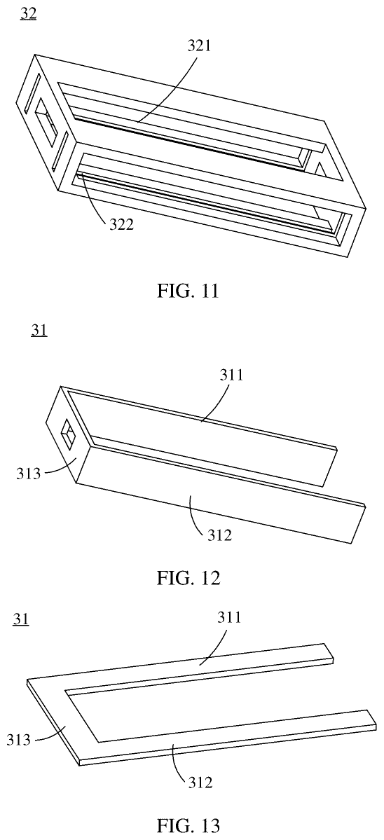

In a specific implementation, FIG. 11 is a diagram of a structure of a second connecting piece 32 according to an embodiment. Referring to FIG. 11, a through hole 321 is disposed in the second connecting piece 32, the sliding dielectric 31 penetrates through the through hole 321, and a sliding slot 322 is disposed on an inner wall of the second connecting piece 32. For example, the sliding slot 322 may be disposed on the bottom plate 13 of the cavity 1, or may be disposed on each of the first side plate 11 and the second side plate 12 of the cavity 1. The sliding dielectric 31 is slidably connected to the sliding slot 322.

The second connecting piece 32 is of a hollow structure, and the sliding dielectric 31 may be accommodated in the through hole 321. The through hole 321 can provide stable support for the sliding dielectric 31, and can also provide space for movement of the sliding dielectric 31. In addition, the sliding slot 322 is disposed, so that sliding of the sliding dielectric 31 can be guided, thereby ensuring that the sliding dielectric 31 can stably slide.

In a specific implementation, FIG. 12 is a diagram of a structure of a sliding dielectric 31 according to an embodiment. Referring to FIG. 12, the sliding dielectric 31 includes a first sliding part 311, a second sliding part 312, and a connecting part 313, and the first sliding part 311 and the second sliding part 312 are respectively connected to two opposite ends of the connecting part 313, so that the first sliding part 311, the second sliding part 312, and the connecting part 313 form a U shape. The first sliding part 311 and the second sliding part 312 are respectively slidably connected to corresponding sliding slots 322 on the inner wall of the second connecting piece 32.

Two opposite side walls of the second connecting piece 32 are respectively fastened to the first side plate 11 and the second side plate 12 of the cavity 1, and the sliding slots 322 are disposed on both inner surfaces of the two side walls of the second connecting piece 32, so that the first sliding part 311 and the second sliding part 312 are slidably connected to the corresponding sliding slots 322, thereby ensuring smoothness of sliding of the sliding dielectric 31. The first sliding part 311 is coupled to the first phase shift segment 21 on the first side plate 11, and the second sliding part 312 is coupled to the second phase shift segment 22 on the second side plate 12. The first sliding part 311 and the second sliding part 312 move, so that an amount of coupling between the first sliding part 311 and the first phase shift segment 21 may be changed, and an amount of coupling between the second sliding part 312 and the second phase shift segment 22 may be changed, to change an electrical length, thereby implementing phase adjustment. Referring to FIG. 12, coupling surfaces of the first sliding part 311 and the second sliding part 312 may be parallel to each other, so that the sliding dielectric 31 forms a three-dimensional structure. In addition, in some other embodiments, FIG. 13 is a diagram of a structure of a sliding dielectric 31 according to another embodiment. Referring to FIG. 13, coupling surfaces of the first sliding part 311 and the second sliding part 312 may be coplanar, so that the sliding dielectric 31 forms a planar structure. A specific shape of the sliding dielectric 31 may be designed based on an arrangement form of the first phase shift assembly 2, so that the first sliding part 31 and the second sliding part 31 can be effectively coupled to the first phase shift assembly 2, thereby implementing a phase shift function.

In a specific implementation, referring to FIG. 1, the second phase shift assembly 3 further includes a dielectric pull-rod 33, and the dielectric pull-rod 33 is connected to the sliding dielectric 31. The dielectric pull-rod 33 may be controlled, through a transmission apparatus, to move, and can drive the sliding dielectric 31 to synchronously move, thereby implementing a limiting adjustment function.

The foregoing descriptions are merely embodiments, and are not intended as limiting. For a person skilled in the art, the embodiments may have various modifications and variations. Any modification, equivalent replacement, or improvement made without departing from the spirit and principle of the embodiments shall fall within their scope.

1. A phase shifter comprising:
a cavity, wherein at least a part of the cavity is made of a metal material;
a first phase shift assembly that is connected to the cavity and is grounded through the metal part of the cavity, the first phase shift assembly comprising an input port and an output port; and
a second phase shift assembly that is slidably disposed in the cavity and coupled to the first phase shift assembly.

2. The phase shifter according to claim 1, wherein the input port and the output port are respectively located at two ends of the cavity in a length direction.

3. The phase shifter according to claim 1, wherein the cavity comprises a first side plate, a second side plate, and a bottom plate, the first side plate and the second side plate are respectively connected to two opposite ends of the bottom plate, and an opening is formed between an end that is of the first side plate and that is away from the bottom plate and an end that is of the second side plate and that is away from the bottom plate; and
the first phase shift assembly is electrically coupled to metal parts of the first side plate and the second side plate and/or a metal part of the bottom plate.

4. The phase shifter according to claim 3, wherein the ends of the first side plate and the second side plate that are away from the bottom plate both have flanges, and the opening is formed between the two flanges; and
the first phase shift assembly is electrically coupled to metal parts of the flanges.

5. The phase shifter according to claim 4, wherein the first phase shift assembly comprises a first phase shift segment and a second phase shift segment, the first phase shift segment is electrically coupled to the first side plate and the bottom plate and/or the flange, and the second phase shift segment is electrically coupled to the second side plate and the bottom plate and/or the flange; and
the input port is disposed in one of the first phase shift segment and the second phase shift segment, and the output port is disposed in the other.

6. The phase shifter according to claim 1, wherein the phase shifter further comprises a first connecting piece, and two ends of the first connecting piece are respectively connected to the cavity and the first phase shift assembly, so that the first phase shift assembly is coupled to the cavity.

7. The phase shifter according to claim 6, wherein a clamping groove is disposed in the first connecting piece, and the first phase shift assembly is clamped in the clamping groove.

8. The phase shifter according to claim 1, wherein the second phase shift assembly comprises a sliding dielectric and a second connecting piece, the second connecting piece is connected to the cavity, the sliding dielectric is slidably connected to the second connecting piece, and a position of the sliding dielectric is aligned with a position of the first phase shift assembly.

9. The phase shifter according to claim 8, wherein a through hole is provided in the second connecting piece, the sliding dielectric penetrates through the through hole, a sliding slot is disposed on an inner wall of the second connecting piece, and the sliding dielectric is slidably connected to the sliding slot.

10. The phase shifter according to claim 9, wherein the sliding dielectric comprises a first sliding part, a second sliding part, and a connecting part, and the first sliding part and the second sliding part are respectively connected to two opposite ends of the connecting part so that the first sliding part, the second sliding part, and the connecting part form a U shape; and
the first sliding part and the second sliding part are respectively slidably connected to corresponding sliding slots on the inner wall of the second connecting piece.

11. The phase shifter according to claim 8, wherein the second phase shift assembly further comprises a dielectric pull-rod, and the dielectric pull-rod is connected to the sliding dielectric.

12. The phase shifter according to claim 8, wherein a material of the second connecting piece is plastic, rubber, or silica gel.

13. The phase shifter according to claim 8, wherein the second connecting piece is connected to the cavity through a screw or a rivet, or the second connecting piece is connected to the cavity by using a hot melt process.

14. A base station antenna, comprising:
a phase shifter, and the phase shifter comprises:
a cavity, wherein at least a part of the cavity is made of a metal material;
a first phase shift assembly that is connected to the cavity and is grounded through the metal part of the cavity, the first phase shift assembly comprising an input port and an output port; and
a second phase shift assembly that is slidably disposed in the cavity and coupled to the first phase shift assembly.

15. The phase shifter according to claim 14, wherein the input port and the output port are respectively located at two ends of the cavity in a length direction.

16. The phase shifter according to claim 14, wherein the cavity comprises a first side plate, a second side plate, and a bottom plate, the first side plate and the second side plate are respectively connected to two opposite ends of the bottom plate, and an opening is formed between an end that is of the first side plate and that is away from the bottom plate and an end that is of the second side plate and that is away from the bottom plate; and
the first phase shift assembly is electrically coupled to metal parts of the first side plate and the second side plate and/or a metal part of the bottom plate.

17. The phase shifter according to claim 16, wherein the ends of the first side plate and the second side plate that are away from the bottom plate both have flanges, and the opening is formed between the two flanges; and
the first phase shift assembly is electrically coupled to metal parts of the flanges.

18. The phase shifter according to claim 17, wherein the first phase shift assembly comprises a first phase shift segment and a second phase shift segment, the first phase shift segment is electrically coupled to the first side plate and the bottom plate and/or the flange, and the second phase shift segment is electrically coupled to the second side plate and the bottom plate and/or the flange; and
the input port is disposed in one of the first phase shift segment and the second phase shift segment, and the output port is disposed in the other.

19. The phase shifter according to claim 14, wherein the phase shifter further comprises a first connecting piece, and two ends of the first connecting piece are respectively connected to the cavity and the first phase shift assembly so that the first phase shift assembly is coupled to the cavity.

20. The phase shifter according to claim 19, wherein a clamping groove is disposed in the first connecting piece, and the first phase shift assembly is clamped in the clamping groove.
